(19) United States
(12) Patent Application Publication
(10) Pub. No.: US 2018/0178148 A1
(43) Pub. Date: Jun. 28, 2018

(54) Water Filter with Integral Electro Optic System for Testing and Indicating the State of the Filter

(71) Applicants: Erez Mazor, Givat Avni (IL); Ronen Aharon Cohen, Moza Elit (IL); Yaniv Maor, Hashmonaim (IL)

(72) Inventors: Erez Mazor, Givat Avni (IL); Ronen Aharon Cohen, Moza Elit (IL); Yaniv Maor, Hashmonaim (IL)

(21) Appl. No.: 15/857,081

(22) Filed: Dec. 28, 2017

(30) Foreign Application Priority Data
Dec. 28, 2016 (IL) 249833

(51) Int. Cl. B01D 35/143; B01D 35/30; C02F 1/00

(52) U.S. Cl. CPC B01D 35/143; C02F 2209/445; C02F 1/003; B01D 35/30

(57) ABSTRACT

A casing sleeve that includes a built-in integral filter with a filter mesh that is fitted to a filter head of a sleeve water filter that includes a system for testing and indicating the color state of the filter mesh. A filter housing of a water filter that is designed to receive a filter core that includes a system for testing and indicating the color state of the filter mesh of the filter core. The system for testing and indicating the color state of the filter mesh includes an electronic card, a lighting device, an electro-optic sensor, a power source and an indication device.

### TECHNICAL FIELD

The present invention refers to a an electro-optic system for testing and indicating the condition of the filter that is combined with a sleeve of a complete water filter or a filter which is inserted inside a water filter in order to know when to change the filter.

### BACKGROUND ART

Usage of water filters is widely known and they are used to purify and treat water, among other things, drinking water. There are two main types of water filters: The first water filter, hereinafter referred to as the “sleeve water filter”, is a type of water filter that is installed in the refrigerators and systems installed near the sink faucet in kitchens. A sleeve water filter includes a fixed filter head to which a casing sleeve is integrated with an integral filter. When the integral filter needs to be replaced, then the entire casing sleeve that contains the integral sleeve is replaced. The second water filter, hereinafter referred to as the “water filter”, is a type of water filter that includes a permanent filter housing that contain a filter core is, which is periodically replaced by a new filter core according to instructions. Sensor-based methods and systems designed to test the condition of filters are known, but they are based mainly on highly inaccurate electronic sensors. The present invention describes a method and system for testing and indicating the state of the filter core of water filters and the state of the integral filters of the sleeve water filters.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 describes schematically a cross-section of a sleeve water filter (1) that includes a filter head (2), a casing sleeve (3) with an integral filter (4) wrapped with a filter mesh (41) and the system (5).

FIG. 2 T describes schematically a cross-section of a water filter (100) that includes a filter housing (300) and the system (5).

FIG. 3 describes schematically the system (5) that includes an electronic card (51) that includes a timer (511) and an algorithm (512), a lighting device (52), an electro-optical sensor (53), a power source (54) and indication device (55).

FIG. 4 schematically describes the integral unit (11) and the separate unit (12).

### THE INVENTION

The object of the present invention is to provide a casing sleeve (3) that contains internally an integral filter (4) fitted to a fixed filter head (2) of a sleeve water filter (1), wherein the casing sleeve (3) includes a system for testing and indicating the filter condition (5). Another object of the present invention is to provide a filter housing (300) of a water filter (100) that includes the system (5).

The sleeve water filter (1), the fixed filter head (2), the casing sleeve (3) and the integral filter (4) can be designed and construed like standard sleeve water to the one subject matter of the present invention lies in the fact that the casing sleeve (3) which is the subject of the present invention, is integrally includes the system for testing and indicating the condition of the filter (5). This is the case with respect to the filter housing (300), which is also a subject matter the present invention, which also includes the system (5).

Standard integral filter (4) usually includes an external circumferential filter mesh (41) that is designed to filter out dirt from the water. The filter mesh (41) inside the casing sleeve (3) is usually light shade, and during usage it accumulates dirt and its color turns dark and murky. The object of the system (5) is to identify the returning wavelengths from the filter mesh (41) and to provide an indication as to the color state of the filter mesh in order to enable the user to know when to change the casing sleeve (3).

The system for testing and indicating the filter condition (5) includes an electronic card (51), a lighting device (52), an electro-optical sensor (53), a power source or internal power supply (54) and indication device (55). The electronic card (51) may include a timer (511) and an algorithm (512).

The operation of the system (5): The lighting device (52) flashes, every certain period of time, light on the filter mesh (41) of the integral filter (4) and the electro-optical sensor (53) identifies the color of the filter mesh (41) based on the returning wavelengths. This information is processed in the electronic card (51) based on the algorithm (512) and the processing result appears on the indication device (55).

The electronic card (51) may include a timer (511) that activates the system (5) every certain period of time, possible for example ones a week for energy saving reasons. Electronic timers that are integrated into electronic cards are known to every expert in the field and this matter does not require unnecessary details. In addition, the electronic card (51) includes the algorithms (512) according to which the information about the wavelengths is processed and the state of the filter mesh of the integral filter is provided. The system (5) identifies the color of the filter mesh (41) based on the wavelength that returns from it to the electro-optical sensor (53). The algorithm (512) compares the wavelengths obtained in the test and when the wavelengths indicate a darker color than predetermined wavelengths, and then an indication is provided. It is possible that the algorithm (512) will include the results of the first test after replacing the casing sleeve (3) as a yardstick for determining when to send an indication of the condition of the filter.

The indication device (55) may be located on the outer side of the casing sleeve (3), and possible in a manner that is visible. In this case, the indication device (55) can be connected to the electronic card (51) and to the internal battery (54) by wires. The indication device (55) displays the current color state of the filter mesh (41) of the integral filter (4).

The indication that is shown in the indication device (55): When the color of a filter mesh exceeds a predetermined threshold, the indication device (55) provides signal that the casing sleeve (3) should be replaced (3). The signal of indication device (55) may be a warning sound, such as buzzer, LEDs that are turned on and off according to the situation and the like. The indication device (55) may indicate that the integral filter is in a goof condition or indicate that it is dirty and soon the casing sleeve should have to be replaced or indicate that the replacement is necessary now. For example, the indication device may have three LEDs: Green—the integral filter is clean and has not reached the predetermined pollution threshold. Yellow—the filter is dirty and soon the sleeve should be replaced. Red—replace the sleeve immediately. It is also possible that the indication device will indicate the need to change the casing sleeve based on the passing of time from the beginning of use. For example, if the indication device has three LEDs, then: red light will be light also after six months since the day of replacing the casing sleeve (3), a yellow light will be on after four or five months, and before that the green LED will be on too. Of course, if the integral filter is previously contaminated by a predetermined threshold then the relevant lights will be lit even if the time periods have not passed.

The way the system (5) is assembled on the casing sleeve: The system (5) can be structured built-in on the casing sleeve (3). The system (5) can be structured on the inner wall (31) of the casing sleeve (3) although the indication device (55) will be visible and affixed on the outer wall (32) of the casing sleeve (3). In this case, the casing sleeve shall include a hole (33) suitable to be waterproof for preventing water leaks.

The system (5) can be structured built-in on the outer wall (32) of the casing sleeve (3) and in this case the casing sleeve will include a hole covered with transparent material that will enable the light flash towards the filter mesh (41) and receiving of the returned light by the electro-optical sensor (53).

It is also possible that the system (5) will also include a receiver (56) and transmitter (57) so that the side of the casing sleeve (3) will consist of an integral unit (11) that will include the power source (54), the electronic card (51), the indication device (55), and a receiver (56) that will transmit the information about the color of the filter mesh to a separate unit (12) that can be placed nearby and which will include a power source (54), an electronic card (51), an indication device (55), and a receiver (56). In this case, the integral unit (11) is structured built-in on the casing sleeve (3) and therefore thrown together with it at the end of use, while the separate unit (12) can be used for a long period of time, thus reducing the costs of the system (5).

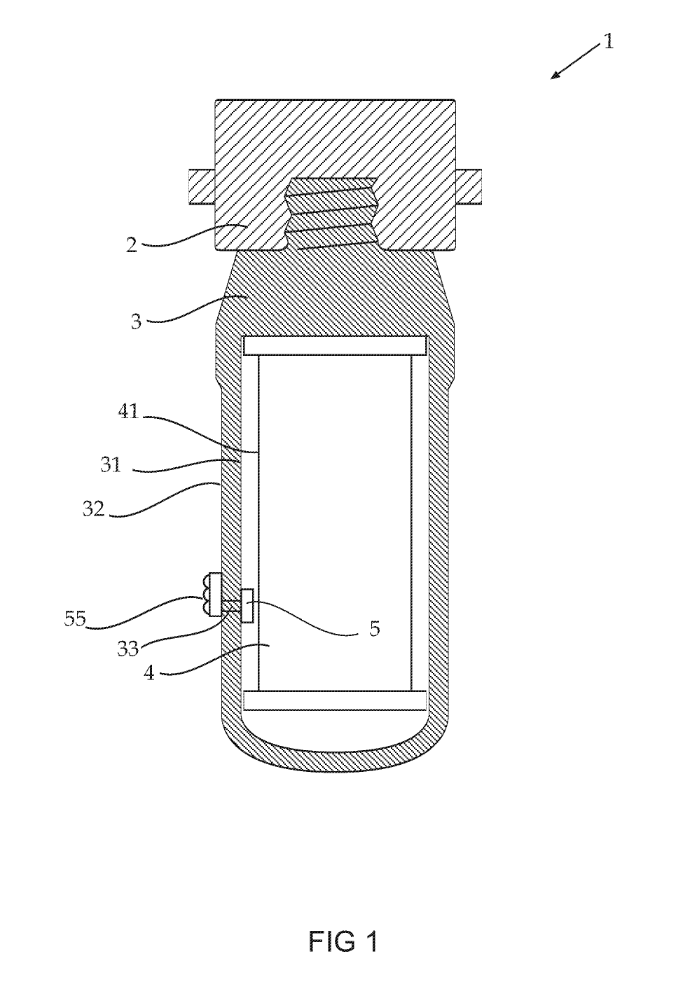

FIG. 1 describes schematically a cross-section of a sleeve water filter (1) that includes the filter head (2), the casing sleeve (3) with an integral filter (4) wrapped with a filter mesh (41) and the system (5) integrated on the inner wall (32) of the casing t sleeve (3) while the indication device (55) is structured on the outer wall (32) of the casing sleeve (3).

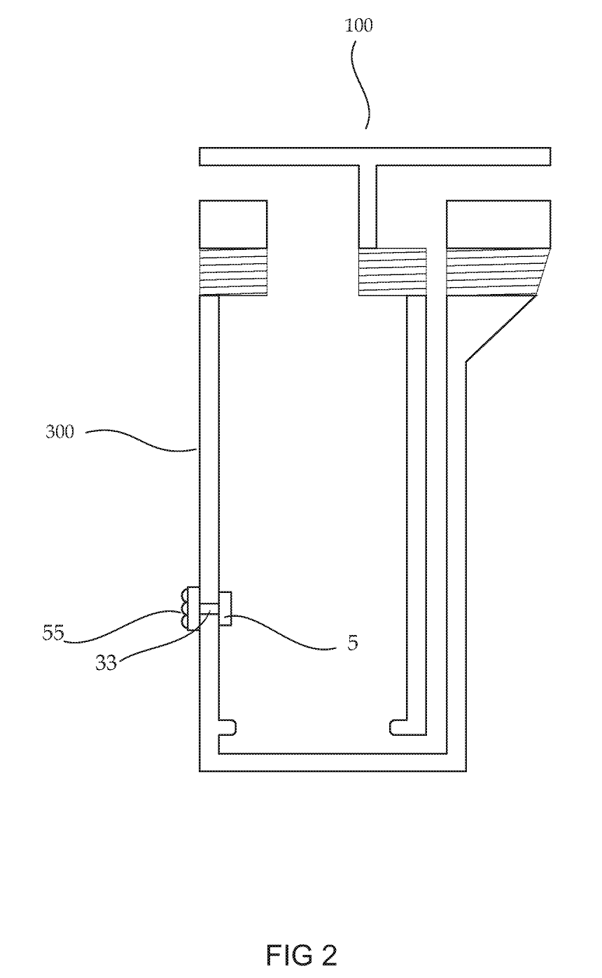

The invention as described above can also be applied on a filter housing (300) of a water filter (100) as described for example in FIG. 2 which schematically describes a cross-section of a water filter (100) that includes a filter house (300) with a filter core wrapped with a filter mesh and the system (5).

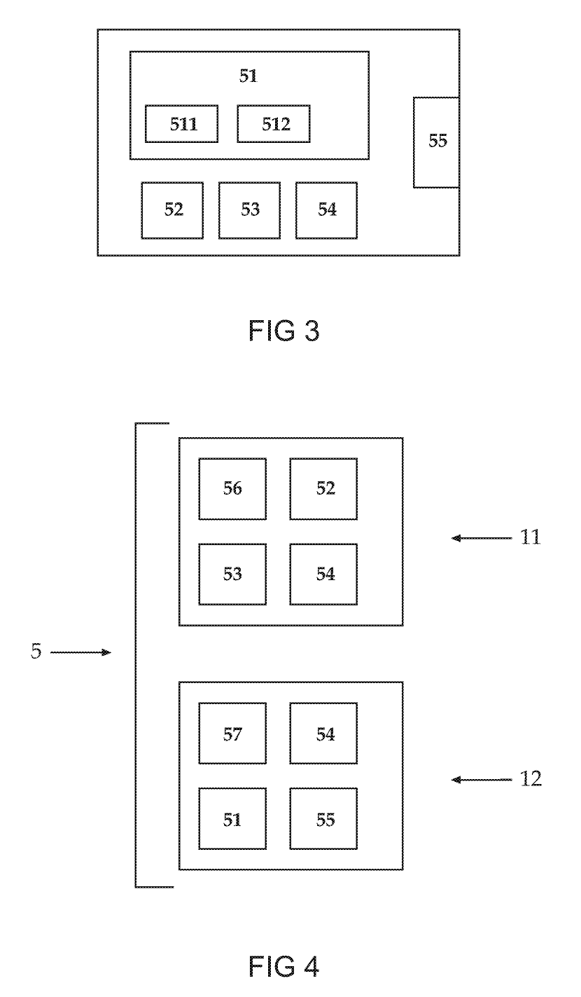

FIG. 3 describes schematically the system (5) which includes an electronic card (51) which includes a timer (511) and an algorithm (512), a lighting device (52), an electro-optical sensor (53), a power source (54) and indication device (55). FIG. 4 schematically describes the integral unit (11) and the separate unit (12).

What is claimed is:

1. A casing sleeve that includes a built-in integral filter with a filter mesh that is fitted to a filter head of a sleeve water filter, wherein said casing sleeve includes a system for testing and indicating the color state of the filter mesh; wherein the system for testing and indicating the color state of the filter mesh includes an electronic card, a lighting device, an electro-optic sensor, an internal power source and an indication devices.

2. The casing sleeve that includes a built-in integral filter with a filter mesh that is fitted to a filter head of a sleeve water filter according to claim 1 wherein said electronic card includes also a timer that is designed to activate said system every certain periods of time and an algorithm according to which the information is processed and color state of said filter mesh is indicated.

3. A filter housing of a water filter which is designed to contain a filter core with filter mesh, wherein said filter housing includes a system for testing and indicating the color state of the filter mesh; wherein the system for testing and indicating the color state of the filter mesh includes an electronic card, a lighting device, an electro-optic sensor, an internal power source and an indication devices.

4. The filter housing of a water filter which is designed to contain a filter core with filter mesh according to claim 3 wherein said electronic card includes also a timer that is designed to activate said system every certain periods of time and an algorithm according to which the information is processed and color state of said filter mesh is indicated.
